(19) United States
(12) Patent Application Publication
(10) Pub. No.: US 2026/0246894 A1
(43) Pub. Date: Aug. 20, 2026

(54) METHOD FOR FRAME RATE REGULATION FOR DISPLAY DEVICE, ELECTRONIC DEVICE AND COMPUTER-READABLE STORAGE MEDIUM

(71) Applicant: Beijing Zitiao Network Technology Co., Ltd., Beijing (CN)

(72) Inventors: Zheng LI, Beijing (CN); Xiaocheng LI, Beijing (CN)

(21) Appl. No.: 19/540,417

(22) Filed: Feb. 13, 2026

(30) Foreign Application Priority Data
Feb. 18, 2025 (CN) 202510180376.3

(51) Int. Cl. H04N 5/77; G09G 5/00

(52) U.S. Cl. CPC H04N 5/772; G09G 5/00; G09G 5/003; G09G 2320/0247

(57) ABSTRACT

Embodiments of the present application provide a method for frame rate regulation for a display device, an electronic device, and a computer-readable storage medium. The method includes: acquiring an actual frame rate and an adaptation frame rate of a display device within a first period of time, the adaptation frame rate being a frame rate corresponding to a performance score of the display device; acquiring an accumulated frame rate error of the display device within the first period of time, according to the actual frame rate and the adaptation frame rate of the display device within the first period of time; acquiring a frame rate regulation rate, according to the accumulated frame rate error and a preset adjustment coefficient; and regulating a frame rate of the display device, according to the frame rate regulation rate, within a second period of time after the first period of time.

### CROSS-REFERENCE TO RELATED APPLICATION

The present disclosure claims the priority and benefits of Chinese patent application No. 202510180376.3 entitled “METHOD AND APPARATUS FOR FRAME RATE REGULATION FOR DISPLAY DEVICE” and filed in Chinese Patent Office on Feb. 18, 2025, the entirety of which is incorporated into the present disclosure by reference.

### TECHNICAL FIELD

The present application relates to the technical field of frame rate regulation, and in particular, to a method for frame rate regulation for a display device, an electronic device, and a computer-readable storage medium.

### BACKGROUND

The frame rate of a display device refers to the number of updates of a user interface displayed by the display device per unit time, and is usually measured in frames per second (Frames Per Second, FPS). A higher frame rate means that the interface is updated more frequently, which may provide smoother animation effects and interaction responses, thus bring better visual experience for users. However, a higher frame rate also requires more supportive system resources.

In some scenarios, a stable frame rate may bring better experience for users than a slightly higher but suddenly changing frame rate. For example, in a video playback scenario, a stable frame rate may allow users to enjoy the plot development, exciting pictures and delicate performances of a video smoothly, and avoid the immersion of the video from being destroyed by picture buffering. On the contrary, when the frame rate is unstable, eyes need to constantly adapt to the changing speed of pictures, which may lead to eye fatigue and further affect the user's viewing experience. Therefore, how to regulate the frame rate of a display device such that it changes based on performance while avoiding sudden changes in the frame rate is an urgent problem to be solved.

### SUMMARY

The embodiments of the present application provide the following technical solutions:

In a first aspect, an embodiment of the present application provides a method for frame rate regulation for a display device, including:
acquiring an actual frame rate and an adaptation frame rate of a display device within a first period of time, the adaptation frame rate being a frame rate corresponding to a performance score of the display device;
acquiring an accumulated frame rate error of the display device within the first period of time, according to the actual frame rate and the adaptation frame rate of the display device within the first period of time;
acquiring a frame rate regulation rate, according to the accumulated frame rate error and a preset adjustment coefficient; and
regulating the frame rate of the display device, according to the frame rate regulation rate, within a second period of time after the first period of time.

As an optional implementation of the embodiments of the present application, an end point of the first period of time is a sampling moment of a current sampling period, and a length of the first period of time is less than a length of the sampling period; and the acquiring the actual frame rate of the display device within the first period of time includes:
acquiring a first actual frame rate and a second actual frame rate, the first actual frame rate being a frame rate of the display device acquired in the current sampling period, and the second actual frame rate being a frame rate of the display device acquired in a previous sampling period;
constructing a first linear equation, according to the first actual frame rate and the second actual frame rate; and
determining the actual frame rate of the display device within the first period of time, according to the first linear equation.

As an optional implementation of the embodiments of the present application, an end point of the first period of time is a sampling moment of a current sampling period, and a length of the first period of time is less than a length of the sampling period; and the acquiring the adaptation frame rate of the display device within the first period of time includes:
acquiring a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period;
acquiring respectively a first adaptation frame rate corresponding to the first performance score and a second adaptation frame rate corresponding to the second performance score;
constructing a second linear equation, according to the first adaptation frame rate and the second adaptation frame rate; and
determining the adaptation frame rate of the display device within the first period of time, according to the second linear equation.

As an optional implementation of the embodiments of the present application, the acquiring respectively the first adaptation frame rate corresponding to the first performance score and the second adaptation frame rate corresponding to the second performance score includes:
determining a first frame rate value space of the first performance score and a second frame rate value space of the second performance score;
acquiring a first probability of each frame rate in the first frame rate value space, the first probability of any frame rate being a probability that the frame rate is the frame rate of the display device when the performance score is the first performance score;
determining a frame rate with a largest first probability in the first frame rate value space, as the first adaptation frame rate;
acquiring a second probability of each frame rate in the second frame rate value space, the second probability of any frame rate being a probability that the frame rate is the frame rate of the display device when the performance score is the second performance score; and
determining a frame rate with a largest second probability in the second frame rate value space, as the second adaptation frame rate.

As an optional implementation of the embodiments of the present application, a length of the second period of time is less than or equal to a sampling period of the actual frame rate.

As an optional implementation of the embodiments of the present application, the method further includes:
obtaining a predicted performance score by predicting a performance score of the display device to be acquired in a next sampling period;
acquiring a third adaptation frame rate corresponding to the predicted performance score; and
regulating the frame rate of the display device, according to the third adaptation frame rate.

As an optional implementation of the embodiments of the present application, the obtaining the predicted performance score by predicting the performance score of the display device to be acquired in the next sampling period includes:
acquiring a transition matrix corresponding to each performance indicator of the display device, an element on an i^{th} row and j^{th} column in the transition matrix corresponding to any performance indicator being a probability that the performance indicator is transited from an i^{th} interval to a j^{th} interval;
predicting, according to the transition matrix corresponding to each performance indicator of the display device and each performance indicator of the display device acquired in a current sampling period, a performance indicator of the display device to be acquired in the next sampling period; and
acquiring the predicted performance score, according to the predicted performance indicator of the display device to be acquired in the next sampling period.

As an optional implementation of the embodiments of the present application, the obtaining the predicted performance score by predicting the performance score of the display device to be acquired in the next sampling period includes:
acquiring performance scores of the display device acquired in a preset number of latest sampling periods; and
predicting the predicted performance score by performing weighted summation on the performance scores of the display device acquired in the preset number of latest sampling periods, according to weights of the preset number of latest sampling periods.

In a second aspect, an embodiment of the present application provides an apparatus for frame rate regulation for a display device, including:
a sampling unit, configured to acquire an actual frame rate and an adaptation frame rate of a display device within a first period of time, the adaptation frame rate being a frame rate corresponding to a performance score of the display device;
a processing unit, configured to acquire an accumulated frame rate error of the display device within the first period of time, according to the actual frame rate and the adaptation frame rate of the display device within the first period of time;
an acquiring unit, configured to acquire a frame rate regulation rate, according to the accumulated frame rate error and a preset adjustment coefficient; and
a regulating unit, configured to regulate a frame rate of the display device, according to the frame rate regulation rate, within a second period of time after the first period of time.

As an optional implementation of the embodiments of the present application, an end point of the first period of time is a sampling moment of a current sampling period, and a length of the first period of time is less than a length of the sampling period, and the sampling unit is further configured to acquire a first actual frame rate and a second actual frame rate, the first actual frame rate being a frame rate of the display device acquired in the current sampling period, and the second actual frame rate being a frame rate of the display device acquired in a previous sampling period; construct a first linear equation, according to the first actual frame rate and the second actual frame rate; and determine the actual frame rate of the display device within the first period of time, according to the first linear equation.

As an optional implementation of the embodiments of the present application, an end point of the first period of time is a sampling moment of a current sampling period, and a length of the first period of time is less than a length of the sampling period; and the sampling unit is further configured to acquire a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period; acquire respectively a first adaptation frame rate corresponding to the first performance score and a second adaptation frame rate corresponding to the second performance score; construct a second linear equation, according to the first adaptation frame rate and the second adaptation frame rate; and determine the adaptation frame rate of the display device within the first period of time, according to the second linear equation.

As an optional implementation of the embodiments of the present application, the sampling unit is further configured to determine a first frame rate value space of the first performance score and a second frame rate value space of the second performance score; acquire a first probability of each frame rate in the first frame rate value space, the first probability of any frame rate being a probability that the frame rate is the frame rate of the display device when the performance score is the first performance score; determine a frame rate with a largest first probability in the first frame rate value space, as the first adaptation frame rate; acquire a second probability of each frame rate in the second frame rate value space, the second probability of any frame rate being a probability that the frame rate is the frame rate of the display device when the performance score is the second performance score; and determine a frame rate with a largest second probability in the second frame rate value space, as the second adaptation frame rate.

As an optional implementation of the embodiments of the present application, a length of the second period of time is less than or equal to a sampling period of the actual frame rate.

As an optional implementation of the embodiments of the present application, the processing unit is further configured to obtain a predicted performance score by predicting a performance score of the display device to be acquired in a next sampling period; and acquire a third adaptation frame rate corresponding to the predicted performance score; and

the regulating unit is further configured to regulate the frame rate of the display device, according to the third adaptation frame rate.

As an optional implementation of the embodiments of the present application, the processing unit is further configured to acquire a transition matrix corresponding to each performance indicator of the display device, an element on an i^{th} row and j^{th} column in the transition matrix corresponding to any performance indicator being a probability that the performance indicator is transited from an i^{th} interval to a j^{th} interval; predict, according to the transition matrix corresponding to each performance indicator of the display device and each performance indicator of the display device acquired in a current sampling period, a performance indicator of the display device to be acquired in the next sampling period; and acquire the predicted performance score, according to the predicted performance indicator of the display device to be acquired in the next sampling period.

As an optional implementation of the embodiments of the present application, the processing unit is further configured to acquire performance scores of the display device acquired in a preset number of latest sampling periods; and perform weighted summation on the performance scores of the display device acquired in the preset number of latest sampling periods, according to weights of the preset number of latest sampling periods, to predict the predicted performance score.

In a third aspect, an embodiment of the present application provides an electronic device, including: a memory and a processor, the memory is configured to store a computer program, and the processor is configured to, when executing the computer program, cause the electronic device to implement the method for frame rate regulation for the display device according to any of the above implementations.

In a fourth aspect, an embodiment of the present application provides a computer-readable storage medium, the computer program, when executed by a computing device, causing the computing device to implement the method for frame rate regulation for the display device according to any of the above implementations.

In a fifth aspect, an embodiment of the present application provides a computer program product, which, when running on a computer, causes the computer to implement the method for frame rate regulation for the display device according to any of the above implementations.

### BRIEF DESCRIPTION OF DRAWINGS

The drawings herein, which are incorporated in and constitute a part of this specification, illustrate embodiments consistent with the present application and, together with the description, serve to explain the principles of the present application. In order to more clearly explain the technical solutions in the embodiments of the present application or in the prior art, the following will briefly introduce the drawings that need to be used in the description of the embodiments or the prior art. Obviously, for those of ordinary skill in the art, other drawings may be obtained based on these drawings without paying creative efforts.

FIG. 1 is a first flowchart of a method for frame rate regulation for a display device provided by an embodiment of the present application;

FIG. 2 is a curve diagram of changes in an actual frame rate and an adaptation frame rate provided by an embodiment of the present application;

FIG. 3 is a second flowchart of a method for frame rate regulation for a display device provided by an embodiment of the present application;

FIG. 4 is a third flowchart of a method for frame rate regulation for a display device provided by an embodiment of the present application;

FIG. 5 is a structural schematic diagram of an apparatus for frame rate regulation for a display device provided by an embodiment of the present application; and

FIG. 6 is a schematic diagram of a hardware structure of an electronic device provided by an embodiment of the present application.

### DETAILED DESCRIPTION

In order to understand the above objectives, features and advantages of the present application more clearly, the solutions of the present application will be further described below. It should be noted that the embodiments of the present application and the features in the embodiments may be combined with each other without conflict.

Many specific details are set forth in the following description to facilitate a full understanding of the present application, but the present application may also be implemented in other ways different from those described herein. Obviously, the embodiments in the specification are merely part of the embodiments of the present application, but not all of the embodiments.

In the embodiments of the present application, words such as “exemplary” or “for example” are used to represent examples, illustrations or descriptions. Any embodiment or design solution described as “exemplary” or “for example” in the embodiments of the present application should not be interpreted as more preferred or more advantageous than other embodiments or design solutions. Precisely speaking, the words such as “exemplary” or “for example” are intended to present related concepts in a specific way. In addition, in the description of the embodiments of the present application, unless otherwise stated, the meaning of “a plurality of” refers to two or more.

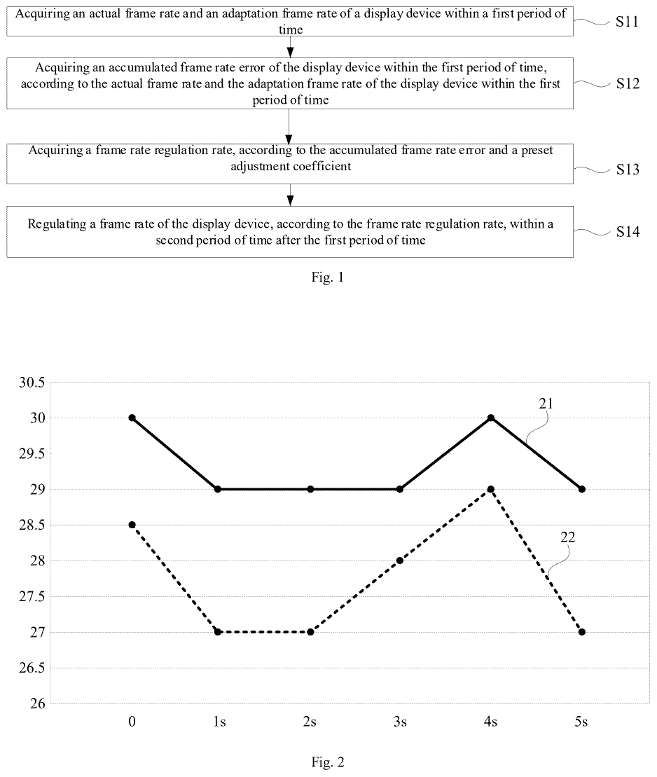

An embodiment of the present application provides a method for frame rate regulation for a display device. An execution body of the method for frame rate regulation for the display device may be a display device such as a mobile phone, a personal computer (PC), a tablet computer, a wearable device, or a vehicle-mounted device, or an apparatus for frame rate regulation for the display device integrated in the display device. Referring to FIG. 1, the method for frame rate regulation for the display device includes the following steps S11 to S14:

S11: acquiring an actual frame rate and an adaptation frame rate of a display device within a first period of time.

The adaptation frame rate is a frame rate corresponding to a performance score of the display device.

In some embodiments, an end point of the first period of time is a sampling moment of a current sampling period, and a length of the first period of time is less than a length of the sampling period. The acquiring the actual frame rate of the display device within the first period of time in the above step S11 includes the following steps 1 to 3:

Step 1: acquiring a first actual frame rate and a second actual frame rate.

The first actual frame rate is a frame rate of the display device acquired in the current sampling period, and the second actual frame rate is a frame rate of the display device acquired in a previous sampling period.

Step 2: constructing a first linear equation, according to the first actual frame rate and the second actual frame rate.

Exemplarily, if the first actual frame rate is f_{actual 1} and the second actual frame rate is f_{actual 2}, the first linear equation constructed according to the first actual frame rate and the second actual frame rate is:

$$f ( t ) = \frac{{f}_{actual 1} - {f}_{actual 2}}{t 1 - t 2} t + {f}_{actual 2} - \frac{{f}_{actual 1} - {f}_{actual 2}}{t 1 - t 2} \times t 1$$

where, t1 is the sampling moment of the current sampling period, and t2 is a sampling moment of the previous sampling period.

Step 3: determining the actual frame rate of the display device within the first period of time, according to the first linear equation.

Exemplarily, when the first period of time is [t3, t2], substituting [t3, t2] into the first linear equation, the actual frame rate at any moment within the first period of time may be acquired.

In some embodiments, an end point of the first period of time is a sampling moment of a current sampling period, and a length of the first period of time is less than a length of the sampling period. The acquiring the adaptation frame rate of the display device within the first period of time in the above step S11 includes the following steps a to d:

Step a: acquiring a first performance score and a second performance score.

The first performance score is a performance score of the display device determined according to a performance indicator and a frame rate of the display device that are acquired in the current sampling period, and the second performance score is a performance score of the display device determined according to a performance indicator and a frame rate of the display device that are acquired in a previous sampling period.

Exemplarily, the performance indicator of the display device may include one or more of: startup data of the display device, memory data of the display device, CPU data of the display device, power of the display device, whether the display device is charging, whether the display device is connected to a wireless network, and the like.

In some embodiments, an implementation of acquiring the first performance score and the second performance score may include: by using the performance indicator of the display device acquired in the current sampling period and the performance indicator of the display device acquired in the previous sampling period, in combination with model evaluation and performance-related portrait features in a cloud end, calculating, through processing and multi-level weighting, a score that may reflect a current real-time performance state of the display device, as the first performance score and the second performance score.

Step b: acquiring respectively a first adaptation frame rate corresponding to the first performance score and a second adaptation frame rate corresponding to the second performance score.

The performance score is a function of the frame rate and the performance indicator. Therefore, it is assumed that the performance score is: runtimescore, the performance indicator is: x₁, x₂, x₃, . . . , xₙ, and the frame rate is: framerate, then the performance score may be expressed as the following function:

$$runtimescore = f ( framerate , {x}_{1} , {x}_{2} , {x}_{3} , … , {x}_{n} )$$

Exemplarily,

$$runtimescore = α * {Score}_{real - timescore} + ( 1 - α ) S c o r {e}_{staticscore}$$

$${Score}_{real - timescore} = {Score}_{startup} * a + S c o r {e}_{framerate} * b + S c o r {e}_{memory} * c + … + {Score}_{state} * n$$

It may be seen from the above equations that the frame rate is also a function with the performance score as a parameter, and the function may be expressed as the following equation:

$$framerate = g ( runtimescore )$$

Therefore, the first adaptation frame rate corresponding to the first performance score and the second adaptation frame rate corresponding to the second performance score may be respectively acquired.

Step c: constructing a second linear equation, according to the first adaptation frame rate and the second adaptation frame rate.

Exemplarily, if the first adaptation frame rate is f_{adaptation 1} and the second adaptation frame rate is f_{adaptation 2}, the second linear equation constructed according to the first adaptation frame rate and the second adaptation frame rate is:

$$f ( t ) = \frac{{f}_{adaptation 1} - {f}_{adaptation 2}}{t 1 - t 2} t + {f}_{adaptation 2} - \frac{{f}_{adaptation 1} - {f}_{adaptation 2}}{t 1 - t 2} \times t 1$$

where, t1 is the sampling moment of the current sampling period, and t2 is the sampling moment of the previous sampling period.

Step d: determining the adaptation frame rate of the display device within the first period of time, according to the second linear equation.

Similarly, when the first period of time is [t3, t1], substituting [t3, t1] into the second linear equation, the adaptation frame rate at any moment within the second period of time may be acquired.

S12: acquiring an accumulated frame rate error of the display device within the first period of time, according to the actual frame rate and the adaptation frame rate of the display device within the first period of time.

Exemplarily, reference is made to FIG. 2, which is a curve chart of actual frame rates and adaptation frame rates of a display device that are acquired periodically at a preset duration. As shown in an actual frame rate represented by a curve 21 and an adaptation frame rate represented by a curve 22 in FIG. 2, there is an error between the actual frame rate and the adaptation frame rate, and the size of the error is different at different moments. It should be noted that FIG. 2 shows that the actual frame rate is always greater than the adaptation frame rate, but the embodiments of the present application are not limited thereto. In practice, the adaptation frame rate may be greater than the actual frame rate, or may be smaller than the actual frame rate, or may be equal to the actual frame rate.

If the error between the actual frame rate and the adaptation frame rate is recorded as e(t), a start point of the first period of time is recorded as t3, and an end moment of the first period of time is recorded as t1, the accumulated frame rate error of the display device within the first period of time may be expressed as:

$${E}_{framerate} = {\int }_{t 3}^{t 1} e ( t ) * dt$$

S13: acquiring a frame rate regulation rate, according to the accumulated frame rate error and a preset adjustment coefficient.

In some embodiments, the preset adjustment coefficient is greater than 0 and less than 1.

In some embodiments, the acquiring the frame rate regulation rate, according to the accumulated frame rate error and the preset adjustment coefficient includes:
calculating a product of the accumulated frame rate error and the preset adjustment coefficient, to acquire the frame rate regulation rate. That is,

$${C}_{framerate} = K * {E}_{framerate} = K * {\int }_{t 3}^{t 1} e ( t ) * d t$$

where, C_{framerate} is the frame rate regulation rate, and K is the preset adjustment coefficient.

It should be noted that the embodiments of the present application do not limit a specific value of the preset adjustment coefficient. If the value of the preset adjustment coefficient is set to be greater, the frame rate regulation rate is greater, and the actual frame rate may approach the adaptation frame rate in a shorter time, but the frame rate of the display device changes faster. On the other hand, if the value of the preset adjustment coefficient is set to be smaller, the frame rate regulation rate is smaller, and the actual frame rate needs a longer time to approach the adaptation frame rate, but the frame rate of the display device is smoother. Therefore, in actual use, the preset adjustment coefficient may be set according to a requirement for the stability of the frame rate.

S14: regulating a frame rate of the display device, according to the frame rate regulation rate, within a second period of time after the first period of time.

In some embodiments, the regulating the frame rate of the display device, according to the frame rate regulation rate includes:
calculating a target frame rate, according to the frame rate regulation rate and a current actual frame rate; and regulating the frame rate of the display device to the target frame rate.

If the frame rate regulation rate is expressed as C_{framerate}, and the current actual frame rate is expressed as T_{current}, a calculation formula for the target frame rate T_{framerate} is:

$${T}_{framerate} = {T}_{current} + K * {\int }_{t 3}^{t 1} e ( t ) * d t$$

According to the method for frame rate regulation for the display device provided by the embodiments of the present application, firstly, an actual frame rate and an adaptation frame rate of the display device within a first period of time are acquired; then, an accumulated frame rate error of the display device within the first period of time is acquired according to the actual frame rate and the adaptation frame rate of the display device within the first period of time; then, a frame rate regulation rate is acquired according to the accumulated frame rate error and a preset adjustment coefficient; and within a second period of time after the first period of time, a frame rate of the display device is regulated according to the frame rate regulation rate. Since the frame rate regulation rate in the embodiments of the present application is acquired according to the accumulated frame rate error between the actual frame rate and the adaptation frame rate corresponding to the performance score of the display device within the first period of time, the method for frame rate regulation for the display device provided by the embodiments of the present application may regulate the frame rate of the display device based on the performance of the display device. Moreover, since the frame rate regulation rate is determined jointly by the accumulated frame rate error and the preset adjustment coefficient, the method for frame rate regulation for the display device provided by the embodiments of the present application may also avoid sudden changes in the frame rate of the display device. In summary, the method for frame rate regulation for the display device provided by the embodiments of the present application may regulate the frame rate of the display device based on the performance of the display device while avoiding sudden changes in the frame rate of the display device.

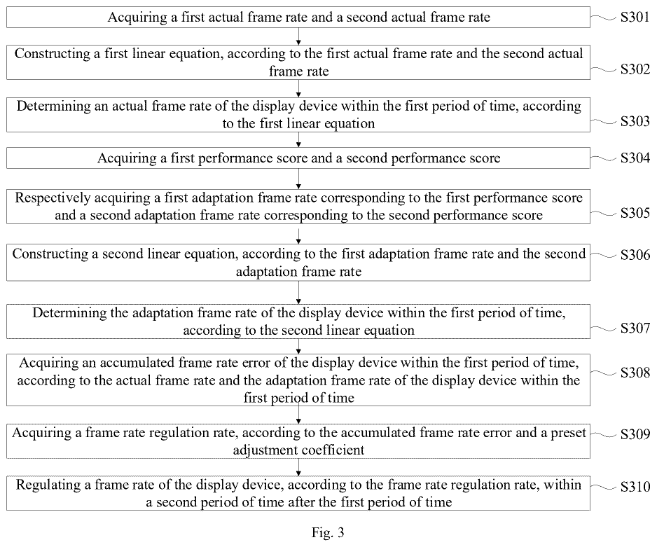

As an extension and refinement of the above embodiments, an embodiment of the present application provides another method for frame rate regulation for a display device. Referring to FIG. 3, the method for frame rate regulation for the display device further includes the following steps:

S301: acquiring a first actual frame rate and a second actual frame rate.

The first actual frame rate is a frame rate of the display device acquired in a current sampling period, and the second actual frame rate is a frame rate of the display device acquired in a previous sampling period.

That is, the frame rate of the display device sampled in the current sampling period and the frame rate of the display device sampled in the previous sampling period are acquired.

S302: constructing a first linear equation, according to the first actual frame rate and the second actual frame rate.

S303: determining an actual frame rate of the display device within the first period of time, according to the first linear equation.

S304: acquiring a first performance score and a second performance score.

The first performance score is a performance score of the display device determined according to a performance indicator and a frame rate of the display device that are acquired in the current sampling period, and the second performance score is a performance score of the display device determined according to a performance indicator and a frame rate of the display device that are acquired in the previous sampling period.

S305: acquiring respectively a first adaptation frame rate corresponding to the first performance score and a second adaptation frame rate corresponding to the second performance score.

In some embodiments, the acquiring respectively the first adaptation frame rate corresponding to the first performance score and the second adaptation frame rate corresponding to the second performance score includes the following steps \textcircled{1} to \textcircled{5}.

Step \textcircled{1}: determining a first frame rate value space of the first performance score and a second frame rate value space of the second performance score.

In some embodiments, statistical analysis may be performed on all the acquired performance indicators and frame rates of the terminal device, to acquire a performance score corresponding to each sampling, so as to obtain a series of performance scores, which may form a value space of the performance score. For each performance score in the value space of the performance score, values of the frame rate when the performance score is the performance score are counted, and these values of the frame rate constitute a frame rate value space of the performance score. A mapping relationship between each performance score in the value space of the performance score and a frame rate value space may be constructed according to the frame rate value space of each performance score in the value space of the performance score, and the first frame rate value space of the first performance score and the second frame rate value space of the second performance score may be acquired by searching the mapping relationship based on the first performance score and the second performance score.

Step \textcircled{2}: acquiring a first probability of each frame rate in the first frame rate value space.

The first probability of any frame rate is a probability that the frame rate is the frame rate of the display device when the performance score is the first performance score.

In some embodiments, the first probability of each frame rate in the first frame rate value space may be acquired by a naive Bayes method.

When a value of the performance score is the first performance score V₁, the probability that the frame rate of the display device is the frame rate fᵢ in the first frame rate value space may be calculated by the following equation:

$$P ( {f}_{i} \vert {V}_{1} ) = \{ P ( {f}_{i} ) {\prod }_{0 < i \leq n} P ( {x}_{1} \vert {f}_{i} ) \} / P ( {V}_{1} )$$

where, P(fᵢ|V₁) is the probability (first probability) that the frame rate of the display device is fᵢ when the performance score is the first performance score V₁, P(fᵢ) is a prior probability of the frame rate, specifically a ratio of the number of samples with the frame rate of fᵢ to the total number of samples, P(x₁|V₁) is a conditional probability of each performance indicator under the frame rate fᵢ, and P(V₁) is a prior probability of the performance score, specifically a ratio of the number of samples with the performance score of V₁ to the total number of samples.

Step \textcircled{3}: determining a frame rate with a largest first probability in the first frame rate value space, as the first adaptation frame rate.

That is, P(fᵢ|V₁) is calculated for each frame rate in the first frame rate value space and compared. If P(fⱼ|V₁) is the largest value, then fⱼ is determined as the first adaptation frame rate.

Step \textcircled{4}: acquiring a second probability of each frame rate in the second frame rate value space.

The second probability of any frame rate is a probability that the frame rate is the frame rate of the display device when the performance score is the second performance score.

Similarly, the second probability of each frame rate in the second frame rate value space may be acquired by the naive Bayes method. For the implementation of acquiring the second probability of each frame rate in the second frame rate value space by the naive Bayes method, reference may be made to the implementation of acquiring the first probability of each frame rate in the first frame rate value space by the naive Bayes method, and details are not repeated here to avoid redundancy.

Step \textcircled{5}: determining a frame rate with a largest second probability in the second frame rate value space, as the second adaptation frame rate.

S306: constructing a second linear equation, according to the first adaptation frame rate and the second adaptation frame rate.

S307: determining the adaptation frame rate of the display device within the first period of time, according to the second linear equation.

S308: acquiring an accumulated frame rate error of the display device within the first period of time, according to the actual frame rate and the adaptation frame rate of the display device within the first period of time.

In some embodiments, the length of the first period of time is less than 1/2 of the sampling period.

In some embodiments, the length of the first period of time is greater than 2 seconds.

S309: acquiring a frame rate regulation rate, according to the accumulated frame rate error and a preset adjustment coefficient.

S310: regulating a frame rate of the display device, according to the frame rate regulation rate, within a second period of time after the first period of time.

In some embodiments, a length of the second period of time is less than or equal to a sampling period of the actual frame rate. That is, the frame rate of the display device is regulated by the frame rate regulation rate in the first half of each sampling period.

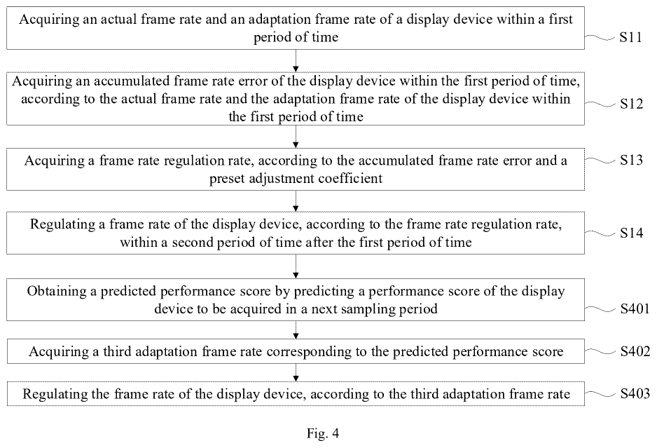

On the basis of the method for frame rate regulation for the display device shown in FIG. 1, when the length of the second period of time is less than or equal to the sampling period of the actual frame rate, referring to FIG. 4, the method for frame rate regulation for the display device provided by the embodiments of the present application further includes the following steps:

S401: obtaining a predicted performance score by predicting a performance score of the display device to be acquired in a next sampling period.

In some embodiments, the obtaining the predicted performance score by predicting the performance score of the display device to be acquired in the next sampling period includes the following steps I to III.

Step I: acquiring a transition matrix corresponding to each performance indicator of the display device.

An element on an i^{th} row and j^{th} column of the transition matrix corresponding to any performance indicator is a probability that the performance indicator shifts from an i^{th} interval to a j^{th} interval.

In some embodiments, for each performance indicator, a value range of the performance indicator is divided into a preset number of value intervals, a transition probability between each of the value intervals is acquired according to a statistical result of market data, and a transition matrix is generated based on the transition probability between each of the value intervals.

In some embodiments, the performance indicator may be clustered by a K-means clustering method, and the value range of the performance indicator is divided into K value intervals according to a clustering result.

That is, K points are randomly selected from a dataset as initial cluster centers, and then for each data point in the dataset, its distance to the K cluster centers is calculated and it is assigned to a cluster where a nearest cluster center is located; then, for each cluster, a mean value of all data points in the cluster is calculated as a new cluster center; and calculating the distance of each data point in the dataset to the K cluster centers, assigning it to the cluster where the nearest cluster center is located, and calculating the mean value of all data points in the cluster as the new cluster center are repeated, until a preset number of iterations is reached or the clustering result does not change.

For example, for the performance indicator memory occupancy, a memory occupancy range may be divided into 5 value intervals (interval 1, interval 2, interval 3, interval 4, and interval 5), and the following transition matrix may be generated:

$$[ \begin{matrix}{P}_{11} & {P}_{12} & {P}_{13} & {P}_{14} & {P}_{15} \\ {P}_{21} & {P}_{22} & {P}_{23} & {P}_{24} & {P}_{25} \\ {P}_{31} & {P}_{32} & {P}_{33} & {P}_{34} & {P}_{35} \\ {P}_{41} & {P}_{42} & {P}_{43} & {P}_{44} & {P}_{45} \\ {P}_{51} & {P}_{52} & {P}_{53} & {P}_{54} & {P}_{55}\end{matrix} ]$$

where, the element on the i^{th} row and j^{th} column is the probability that the memory occupancy shifts from interval i to interval j. For example, P₁₁ represents the probability that the memory occupancy is currently in interval 1 and remains in interval 1 in the next sampling period, and P₂₃ represents the probability that the memory occupancy is currently in interval 2 and is in interval 3 in the next sampling period.

Step II: predicting a performance indicator of the display device to be acquired in the next sampling period, according to the transition matrix corresponding to each performance indicator of the display device and each performance indicator of the display device acquired in the current sampling period.

Continuing with the above example, if the memory occupancy acquired in the current period belongs to interval 2, the magnitude relationship among P₂₁, P₂₂, P₂₃, P₂₄, P₂₅ is compared. If P₂₃ is the largest value among P₂₁, P₂₂, P₂₃, P₂₄, P₂₅, it is predicted that the memory occupancy acquired in the next sampling period belongs to interval 3.

Step III: acquiring the predicted performance score, according to the predicted performance indicator of the display device to be acquired in the next sampling period.

The implementation of acquiring the predicted performance score according to the predicted performance indicator of the display device to be acquired in the next sampling period may be the same as the implementation of acquiring the first performance score according to the performance indicator of the display device acquired in the current period, and details are not repeated here to avoid redundancy.

In other implementations, the obtaining the predicted performance score by predicting the performance score of the display device to be acquired in the next sampling period includes the following steps (1) and (2).

Step (1): acquiring performance scores of the display device acquired in a preset number of latest sampling periods.

Step (2): performing weighted summation on the performance scores of the display device acquired in the preset number of latest sampling periods, according to weights of the preset number of latest sampling periods, to predict the predicted performance score.

In some embodiments, the weight of the sampling period is negatively correlated with a distance from the sampling period to a current moment.

Exemplarily, if the preset number is 2, a calculation formula for predicting the predicted performance score may be:

$${S}_{t} = β * {S}_{t - 2} + ( 1 - β ) {S}_{t - 1}$$

where, Sₜ is the predicted performance score, Sₜ₋₁ is the performance score acquired in the current sampling period, and Sₜ₋₂ is the performance score acquired in a sampling period that the current sampling period follows.

Exemplarily, if the preset number is 3, a calculation formula for predicting the predicted performance score may be:

$${S}_{t} = β * {S}_{t - 3} + γ * {S}_{t - 2} + ( 1 - β - γ ) {S}_{t - 1}$$

where, Sₜ is the predicted performance score, Sₜ₋₁ is the e performance score acquired in the current sampling period, Sₜ₋₂ is the performance score acquired in a sampling period that the current sampling period succeeds, and Sₜ₋₃ is the performance score acquired in a sampling period preceding the sampling period that the current sampling period succeeds.

Exemplarily, if the preset number is 5, a calculation formula for predicting the predicted performance score may be:

$${S}_{t} = δ * {y}_{t} + ( 1 - δ ) {S}_{t - 1} = δ * [ ( {S}_{t - 5} + {S}_{t - 4} + {S}_{t - 3} + {S}_{t - 2} ) / 4 ] + ( 1 - δ ) {S}_{t - 1}$$

where, Sₜ is the predicted performance score, Sₜ₋₁ is the performance score acquired in the current sampling period, Sₜ₋₂ is the performance score acquired in the sampling period that the current sampling period succeeds, Sₜ₋₃ is the performance score acquired in a sampling period that is two sampling periods before the current sampling period, Sₜ₋₄ is the performance score acquired in a sampling period that is three sampling periods before the current sampling period, and Sₜ₋₄ is the performance score acquired in a sampling period that is four sampling periods before the current sampling period.

S402: acquiring a third adaptation frame rate corresponding to the predicted performance score.

The implementation of acquiring the third adaptation frame rate corresponding to the predicted performance score is similar to the implementations of the first adaptation frame rate corresponding to the first performance score and the second adaptation frame rate corresponding to the second performance score, and details are not repeated here to avoid redundancy.

S403: regulating the frame rate of the display device, according to the third adaptation frame rate.

In some embodiments, the regulating the frame rate of the display device, according to the third adaptation frame rate includes: controlling the frame rate of the display device to gradually reach the third adaptation frame rate at a start point of the next sampling period.

Based on the same inventive concept, as an implementation of the above method, an embodiment of the present application further provides an apparatus for frame rate regulation for a display device. This embodiment corresponds to the foregoing method embodiment, and for ease of reading, the content of the foregoing method embodiment will not be described in detail in this embodiment, but it should be clear that the apparatus for frame rate regulation for the display device in this embodiment may correspondingly implement all the content of the foregoing method embodiment.

An embodiment of the present application provides an apparatus for frame rate regulation for a display device. FIG. 5 is a structural schematic diagram of the apparatus for frame rate regulation for the display device. As shown in FIG. 5, the apparatus for frame rate regulation 500 for the display device includes:
a sampling unit 51, configured to acquire an actual frame rate and an adaptation frame rate of a display device within a first period of time, the adaptation frame rate being a frame rate corresponding to a performance score of the display device;
a processing unit 52, configured to acquire an accumulated frame rate error of the display device within the first period of time, according to the actual frame rate and the adaptation frame rate of the display device within the first period of time;
an acquiring unit 53, configured to acquire a frame rate regulation rate, according to the accumulated frame rate error and a preset adjustment coefficient; and
a regulating unit 54, configured to regulate a frame rate of the display device, according to the frame rate regulation rate, within a second period of time after the first period of time.

As an optional implementation of the embodiments of the present application, an end point of the first period of time is a sampling moment of a current sampling period, and a length of the first period of time is less than a length of the sampling period; and the sampling unit 51 is further configured to acquire a first actual frame rate and a second actual frame rate, the first actual frame rate being a frame rate of the display device acquired in the current sampling period, and the second actual frame rate being a frame rate of the display device acquired in a previous sampling period; construct a first linear equation, according to the first actual frame rate and the second actual frame rate; and determine the actual frame rate of the display device within the first period of time, according to the first linear equation.

As an optional implementation of the embodiments of the present application, an end point of the first period of time is a sampling moment of a current sampling period, and a length of the first period of time is less than a length of the sampling period; and the sampling unit 51 is further configured to acquire a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period; acquire respectively a first adaptation frame rate corresponding to the first performance score and a second adaptation frame rate corresponding to the second performance score; construct a second linear equation, according to the first adaptation frame rate and the second adaptation frame rate; and determine the adaptation frame rate of the display device within the first period of time, according to the second linear equation.

As an optional implementation of the embodiments of the present application, the sampling unit 51 is further configured to determine a first frame rate value space of the first performance score and a second frame rate value space of the second performance score; acquire a first probability of each frame rate in the first frame rate value space, the first probability of any frame rate being a probability that the frame rate is the frame rate of the display device when the performance score is the first performance score; determine a frame rate with a largest first probability in the first frame rate value space, as the first adaptation frame rate; acquire a second probability of each frame rate in the second frame rate value space, the second probability of any frame rate being a probability that the frame rate is the frame rate of the display device when the performance score is the second performance score; and determine a frame rate with a largest second probability in the second frame rate value space, as the second adaptation frame rate.

As an optional implementation of the embodiments of the present application, a length of the second period of time is less than or equal to a sampling period of the actual frame rate.

As an optional implementation of the embodiments of the present application, the processing unit 52 is further configured to obtain a predicted performance score by predicting a performance score of the display device to be acquired in a next sampling period; and acquire a third adaptation frame rate corresponding to the predicted performance score; and
the regulating unit is further configured to regulate the frame rate of the display device, according to the third adaptation frame rate.

As an optional implementation of the embodiments of the present application, the processing unit 52 is further configured to acquire a transition matrix corresponding to each performance indicator of the display device, an element on an i^{th} row and j^{th} column in the transition matrix corresponding to any performance indicator being a probability that the performance indicator is transited from an i^{th} interval to a j^{th} interval; predict, according to the transition matrix corresponding to each performance indicator of the display device and each performance indicator of the display device acquired in a current sampling period, a performance indicator of the display device to be acquired in the next sampling period; and acquire the predicted performance score, according to the predicted performance indicator of the display device to be acquired in the next sampling period.

As an optional implementation of the embodiments of the present application, the processing unit 52 is further configured to acquire performance scores of the display device acquired in a preset number of latest sampling periods; and perform weighted summation on the performance scores of the display device acquired in the preset number of latest sampling periods, according to weights of the preset number of latest sampling periods, to predict the predicted performance score.

The apparatus for frame rate regulation for the display device provided by the embodiments of the present application may execute the method for frame rate regulation for the display device provided by any of the above embodiments, and the implementation principles and technical effects thereof are similar, and details are not repeated here.

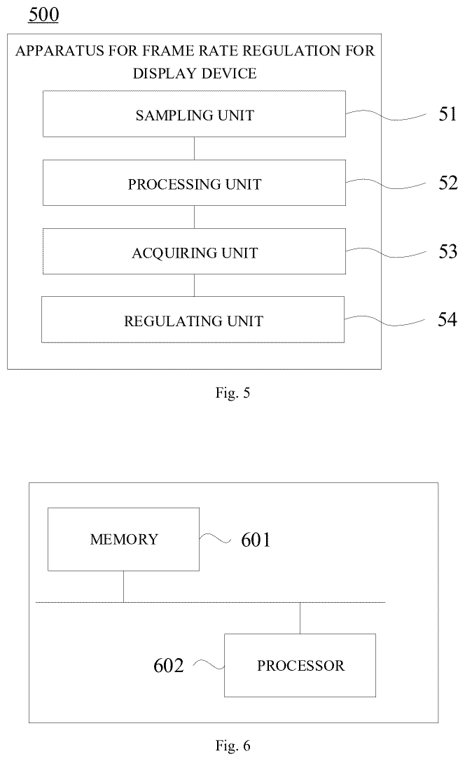

Based on the same inventive concept, an embodiment of the present application further provides an electronic device. FIG. 6 is a structural schematic diagram of an electronic device provided by an embodiment of the present application. As shown in FIG. 6, the electronic device provided by this embodiment includes: a memory 601 and a processor 602, the memory 601 is configured to store a computer program, and the processor 602 is configured to, when executing the computer program, execute the method for frame rate regulation for the display device provided by the above embodiments.

Based on the same inventive concept, an embodiment of the present application further provides a computer-readable storage medium, on which a computer program is stored, the computer program, when executed by a processor, causing a computing device to implement the method for frame rate regulation for the display device provided by the above embodiments.

Based on the same inventive concept, an embodiment of the present application further provides a computer program product, which, when running on a computer, causes a computing device to implement the method for frame rate regulation for the display device provided by the above embodiments.

Those skilled in the art should understand that the embodiments of the present application may be provided as a method, a system, or a computer program product. Therefore, the present application may take the form of an entirely hardware embodiment, an entirely software embodiment, or an embodiment containing both hardware and software elements. Moreover, the present application may take the form of a computer program product implemented on one or more computer-usable storage media having computer-usable program code embodied therein.

The processor may be a central processing unit (CPU), or other general-purpose processor, digital signal processor (DSP), application specific integrated circuit (ASIC), field-programmable gate array (FPGA) or other programmable logic devices, a discrete gate or transistor logic device, a discrete hardware component, etc. The general-purpose processor may be a microprocessor or any conventional processor, etc.

The memory may include non-permanent memory, random access memory (RAM) and/or non-volatile memory in a computer-readable medium, such as read-only memory (ROM) or flash memory (flash RAM). The memory is an example of the computer-readable medium.

The computer-readable medium includes permanent and non-permanent, removable and non-removable storage media. The storage medium may realize information storage by any method or technology, and the information may be computer-readable instructions, data structures, modules of a program or other data. Examples of the computer storage medium include, but are not limited to, a phase-change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, a disk storage or other magnetic storage devices, or any other non-transmission medium, which may be used to store information that may be accessed by a computing device. According to the definition herein, the computer-readable medium does not include transitory media, such as modulated data signals and carrier waves.

Finally, it should be noted that the above embodiments are only used to illustrate the technical solutions of the present application, rather than limiting them. Although the present application has been described in detail with reference to the foregoing embodiments, those of ordinary skill in the art should understand that they may still modify the technical solutions recorded in the foregoing embodiments, or equivalently replace some or all of the technical features. And these modifications or substitutions do not make the essence of the corresponding technical solutions deviate from the scope of the technical solutions of the various embodiments of the present application.

1. A method for frame rate regulation for a display device, comprising:
acquiring an actual frame rate and an adaptation frame rate of the display device within a first period of time, the adaptation frame rate being a frame rate corresponding to a performance score of the display device;
acquiring an accumulated frame rate error of the display device within the first period of time, according to the actual frame rate and the adaptation frame rate of the display device within the first period of time;
acquiring a frame rate regulation rate, according to the accumulated frame rate error and a preset adjustment coefficient; and
regulating a frame rate of the display device, according to the frame rate regulation rate, within a second period of time after the first period of time.

2. The method of claim 1, wherein an end point of the first period of time is a sampling moment of a current sampling period, and a length of the first period of time is less than a length of the sampling period; and the acquiring the actual frame rate of the display device within the first period of time comprises:
acquiring a first actual frame rate and a second actual frame rate, the first actual frame rate being a frame rate of the display device acquired in the current sampling period, and the second actual frame rate being a frame rate of the display device acquired in a previous sampling period;
constructing a first linear equation, according to the first actual frame rate and the second actual frame rate; and
determining the actual frame rate of the display device within the first period of time, according to the first linear equation.

3. The method of claim 1, wherein an end point of the first period of time is a sampling moment of a current sampling period, and a length of the first period of time is less than a length of the sampling period, and the acquiring the adaptation frame rate of the display device within the first period of time comprises:
acquiring a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period;
acquiring respectively a first adaptation frame rate corresponding to the first performance score and a second adaptation frame rate corresponding to the second performance score;
constructing a second linear equation, according to the first adaptation frame rate and the second adaptation frame rate; and
determining the adaptation frame rate of the display device within the first period of time, according to the second linear equation.

4. The method of claim 3, wherein the acquiring respectively the first adaptation frame rate corresponding to the first performance score and the second adaptation frame rate corresponding to the second performance score comprises:
determining a first frame rate value space of the first performance score and a second frame rate value space of the second performance score;
acquiring a first probability of each frame rate in the first frame rate value space, the first probability of any frame rate being a probability that the frame rate is the frame rate of the display device when the performance score is the first performance score;
determining a frame rate with a largest first probability in the first frame rate value space, as the first adaptation frame rate;
acquiring a second probability of each frame rate in the second frame rate value space, the second probability of any frame rate being a probability that the frame rate is the frame rate of the display device when the performance score is the second performance score; and
determining a frame rate with a largest second probability in the second frame rate value space, as the second adaptation frame rate.

5. The method of claim 1, wherein a length of the second period of time is less than or equal to a sampling period of the actual frame rate.

6. The method of claim 5, further comprising:
obtaining a predicted performance score by predicting a performance score of the display device to be acquired in a next sampling period;
acquiring a third adaptation frame rate corresponding to the predicted performance score; and
regulating the frame rate of the display device, according to the third adaptation frame rate.

7. The method of claim 6, wherein the obtaining the predicted performance score by predicting the performance score of the display device to be acquired in the next sampling period comprises:
acquiring a transition matrix corresponding to each performance indicator of the display device, an element on an i^{th} row and j^{th} column in the transition matrix corresponding to any performance indicator being a probability that the performance indicator is transited from an i^{th} interval to a j^{th} interval;
predicting, according to the transition matrix corresponding to each performance indicator of the display device and each performance indicator of the display device acquired in a current sampling period, a performance indicator of the display device to be acquired in the next sampling period; and
acquiring the predicted performance score, according to the predicted performance indicator of the display device to be acquired in the next sampling period.

8. The method of claim 6, wherein the obtaining the predicted performance score by predicting the performance score of the display device to be acquired in the next sampling period comprises:
acquiring performance scores of the display device acquired in a preset number of latest sampling periods; and
performing weighted summation on the performance scores of the display device acquired in the preset number of latest sampling periods, according to weights of the preset number of latest sampling periods, to predict the predicted performance score.

9. An electronic device, comprising:
a processor; and
a memory having computer programs stored thereon, the computer programs, when executed by the processor, cause the processor to perform a method, the method comprising:
acquiring an actual frame rate and an adaptation frame rate of the display device within a first period of time, the adaptation frame rate being a frame rate corresponding to a performance score of the display device;
acquiring an accumulated frame rate error of the display device within the first period of time, according to the actual frame rate and the adaptation frame rate of the display device within the first period of time;
acquiring a frame rate regulation rate, according to the accumulated frame rate error and a preset adjustment coefficient; and
regulating a frame rate of the display device, according to the frame rate regulation rate, within a second period of time after the first period of time.

10. The electronic device of claim 9, wherein an end point of the first period of time is a sampling moment of a current sampling period, and a length of the first period of time is less than a length of the sampling period; and the acquiring the actual frame rate of the display device within the first period of time comprises:
acquiring a first actual frame rate and a second actual frame rate, the first actual frame rate being a frame rate of the display device acquired in the current sampling period, and the second actual frame rate being a frame rate of the display device acquired in a previous sampling period;
constructing a first linear equation, according to the first actual frame rate and the second actual frame rate; and
determining the actual frame rate of the display device within the first period of time, according to the first linear equation.

11. The electronic device of claim 9, wherein an end point of the first period of time is a sampling moment of a current sampling period, and a length of the first period of time is less than a length of the sampling period, and the acquiring the adaptation frame rate of the display device within the first period of time comprises:
acquiring a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period;
acquiring respectively a first adaptation frame rate corresponding to the first performance score and a second adaptation frame rate corresponding to the second performance score;
constructing a second linear equation, according to the first adaptation frame rate and the second adaptation frame rate; and
determining the adaptation frame rate of the display device within the first period of time, according to the second linear equation.

12. The electronic device of claim 11, wherein the acquiring respectively the first adaptation frame rate corresponding to the first performance score and the second adaptation frame rate corresponding to the second performance score comprises:
determining a first frame rate value space of the first performance score and a second frame rate value space of the second performance score;
acquiring a first probability of each frame rate in the first frame rate value space, the first probability of any frame rate being a probability that the frame rate is the frame rate of the display device when the performance score is the first performance score;
determining a frame rate with a largest first probability in the first frame rate value space, as the first adaptation frame rate;
acquiring a second probability of each frame rate in the second frame rate value space, the second probability of any frame rate being a probability that the frame rate is the frame rate of the display device when the performance score is the second performance score; and
determining a frame rate with a largest second probability in the second frame rate value space, as the second adaptation frame rate.

13. The electronic device of claim 9, wherein a length of the second period of time is less than or equal to a sampling period of the actual frame rate.

14. The electronic device of claim 13, further comprising:
obtaining a predicted performance score by predicting a performance score of the display device to be acquired in a next sampling period;
acquiring a third adaptation frame rate corresponding to the predicted performance score; and
regulating the frame rate of the display device, according to the third adaptation frame rate.

15. The electronic device of claim 14, wherein the obtaining the predicted performance score by predicting the performance score of the display device to be acquired in the next sampling period comprises:
acquiring a transition matrix corresponding to each performance indicator of the display device, an element on an i^{th} row and j^{th} column in the transition matrix corresponding to any performance indicator being a probability that the performance indicator is transited from an i^{th} interval to a j^{th} interval;
predicting, according to the transition matrix corresponding to each performance indicator of the display device and each performance indicator of the display device acquired in a current sampling period, a performance indicator of the display device to be acquired in the next sampling period; and
acquiring the predicted performance score, according to the predicted performance indicator of the display device to be acquired in the next sampling period.

16. The electronic device of claim 14, wherein the obtaining the predicted performance score by predicting the performance score of the display device to be acquired in the next sampling period comprises:
acquiring performance scores of the display device acquired in a preset number of latest sampling periods; and
performing weighted summation on the performance scores of the display device acquired in the preset number of latest sampling periods, according to weights of the preset number of latest sampling periods, to predict the predicted performance score.

17. A computer-readable storage medium having computer programs stored thereon, the computer programs, when executed by a computing device, cause the computing device to perform a method, the method comprising:
acquiring an actual frame rate and an adaptation frame rate of the display device within a first period of time, the adaptation frame rate being a frame rate corresponding to a performance score of the display device;
acquiring an accumulated frame rate error of the display device within the first period of time, according to the actual frame rate and the adaptation frame rate of the display device within the first period of time;
acquiring a frame rate regulation rate, according to the accumulated frame rate error and a preset adjustment coefficient; and
regulating a frame rate of the display device, according to the frame rate regulation rate, within a second period of time after the first period of time.

18. The computer-readable storage medium of claim 17, wherein an end point of the first period of time is a sampling moment of a current sampling period, and a length of the first period of time is less than a length of the sampling period; and the acquiring the actual frame rate of the display device within the first period of time comprises:
acquiring a first actual frame rate and a second actual frame rate, the first actual frame rate being a frame rate of the display device acquired in the current sampling period, and the second actual frame rate being a frame rate of the display device acquired in a previous sampling period;
constructing a first linear equation, according to the first actual frame rate and the second actual frame rate; and
determining the actual frame rate of the display device within the first period of time, according to the first linear equation.

19. The computer-readable storage medium of claim 17, wherein an end point of the first period of time is a sampling moment of a current sampling period, and a length of the first period of time is less than a length of the sampling period, and the acquiring the adaptation frame rate of the display device within the first period of time comprises:
acquiring a first performance score and a second performance score, the first performance score being a performance score of the display device determined according to a performance indicator and a frame rate of the display device that are acquired in the current sampling period, and the second performance score being a performance score of the display device determined according to a performance indicator and a frame rate of the display device that are acquired in a previous sampling period;
acquiring respectively a first adaptation frame rate corresponding to the first performance score and a second adaptation frame rate corresponding to the second performance score;
constructing a second linear equation, according to the first adaptation frame rate and the second adaptation frame rate; and
determining the adaptation frame rate of the display device within the first period of time, according to the second linear equation.

20. The computer-readable storage medium of claim 19, wherein the acquiring respectively the first adaptation frame rate corresponding to the first performance score and the second adaptation frame rate corresponding to the second performance score comprises:
determining a first frame rate value space of the first performance score and a second frame rate value space of the second performance score;
acquiring a first probability of each frame rate in the first frame rate value space, the first probability of any frame rate being a probability that the frame rate is the frame rate of the display device when the performance score is the first performance score;
determining a frame rate with a largest first probability in the first frame rate value space, as the first adaptation frame rate;
acquiring a second probability of each frame rate in the second frame rate value space, the second probability of any frame rate being a probability that the frame rate is the frame rate of the display device when the performance score is the second performance score; and
determining a frame rate with a largest second probability in the second frame rate value space, as the second adaptation frame rate.
